(19) United States
(12) Patent Application Publication
(10) Pub. No.: US 2019/0085121 A1
(43) Pub. Date: Mar. 21, 2019

(54) METHOD FOR PRODUCING POLYETHER CARBONATE POLYOLS

(71) Applicant: COVESTRO DEUTSCHLAND AG, Leverkusen (DE)

(72) Inventors: Jörg HOFMANN, Krefeld (DE); Stefanie BRAUN, Köln (DE); Aurel WOLF, Wülfrath (DE)

(73) Assignee: COVESTRO DEUTSCHLAND AG, Leverkusen (DE)

(21) Appl. No.: 16/084,431

(22) PCT Filed: Mar. 16, 2017
(86) PCT No.: PCT/EP2017/056284

§ 371 Date: Sep. 12, 2018

(30) Foreign Application Priority Data
Mar. 18, 2016 (EP) 16161040.7

(51) Int. Cl. C08G 64/34; C08G 65/26

(52) U.S. Cl. CPC C08G 64/34; C08G 65/2606; C08G 65/2663

(57) ABSTRACT

The present invention provides a process for preparing polyether carbonate polyols from H-functional starter substance, alkylene oxide and carbon dioxide in the presence of a DMC catalyst or in the presence of a metal complex catalyst based on the metals zinc and/or cobalt, wherein the carbon dioxide used has a purity of 99.5000% to 99.9449% by volume.

### CROSS-REFERENCE TO RELATED APPLICATIONS

This application is a national stage application under 35 U.S.C. § 371 of PCT/EP2017/056284, filed Mar. 16, 2017, which claims the benefit of European Application No. 16161040.7 filed Mar. 18, 2016, both of which are being incorporated by reference herein.

### FIELD

The present invention relates to a process for preparing polyether carbonate polyols by catalytic copolymerization of carbon dioxide (CO₂) with alkylene oxides onto H-functional starter substances in the presence of a double metal cyanide (DMC) catalyst or in the presence of a metal complex catalyst based on the metals zinc and/or cobalt.

### BACKGROUND

The preparation of polyether carbonate polyols by catalytic reaction of alkylene oxides (epoxides) and carbon dioxide in the presence of H-functional starter substances (“starters”) has been the subject of intensive study for more than 40 years (e.g. Inoue et al., Copolymerization of Carbon Dioxide and Epoxide with Organometallic Compounds; Die Makromolekulare Chemie 130, 210-220, 1969). This reaction is shown in schematic form in scheme (I), where R is an organic radical such as alkyl, alkylaryl or aryl, each of which may also contain heteroatoms, for example O, S, Si etc., and where e, f and g are integers, and where the product shown here in scheme (I) for the polyether carbonate polyol should merely be understood such that blocks having the structure shown may in principle be present in the polyether carbonate polyol obtained, but the sequence, number and length of the blocks and OH functionality of the starter can vary, and is not limited to the polyether carbonate polyol shown in scheme (I). This reaction (see scheme (I)) is environmentally very advantageous since this reaction constitutes the conversion of a greenhouse gas such as CO₂ to a polymer. A further product, actually a by-product, formed is the cyclic carbonate shown in scheme (I) (for example, when R═CH₃, propylene carbonate).

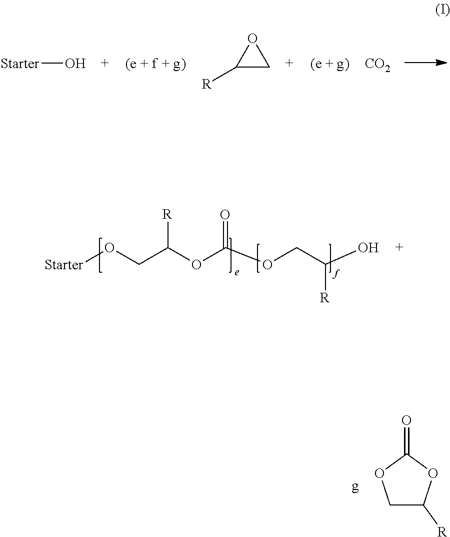

EP-A 0 222 453 discloses a process for preparing polycarbonates from alkylene oxides and carbon dioxide using a catalyst system composed of DMC catalyst and a cocatalyst such as zinc sulfate. This polymerization is initiated by one-off contacting of a portion of the alkylene oxide with the catalyst system. Only thereafter are the remaining amount of alkylene oxide and the carbon dioxide metered in simultaneously. The amount of 60% by weight of alkylene oxide compound relative to the H-functional starter compound, as specified in EP-A 0 222 453 for the activation step in examples 1 to 7, is high and has the disadvantage that this constitutes a certain safety risk for industrial scale applications because of the high exothermicity of the homopolymerization of alkylene oxide compounds.

WO-A 2003/029325 discloses a process for preparing high molecular weight aliphatic polyether carbonate polyols (weight-average molecular weight greater than 30 000 g/mol), in which a catalyst from the group consisting of zinc carboxylate and multimetal cyanide compound is used, this catalyst being anhydrous and first being contacted with at least a portion of the carbon dioxide before the alkylene oxide is added. Final CO₂ pressures of up to 150 bar place very high demands on the reactor and on safety. Even the extremely high pressure of 150 bar resulted in incorporation of only about 33% by weight of CO₂ up to a maximum of 42% by weight of CO₂. The accompanying examples describe the use of a solvent (toluene) which has to be removed again by thermal means after the reaction, thus resulting in increased time and cost demands. Furthermore, the polymers, with a polydispersity of 2.7 or more, have a very broad molar mass distribution.

WO-A 2008/058913 discloses a process for preparing flexible polyurethane foams exhibiting reduced emissions of organic substances, wherein the polyether carbonate polyols employed have a block of pure alkylene oxide units at the chain end.

EP-A 2 530 101 discloses a process for preparing polyether carbonate polyols in which at least one alkylene oxide and carbon dioxide are reacted onto an H-functional starter substance in the presence of a DMC catalyst. However, EP-A 2 530 101 does not disclose how polyether carbonate polyols can be stabilized toward thermal stress in order to achieve a very low content of cyclic carbonate after thermal stress.

U.S. Pat. No. 4,145,525 discloses a process for thermal stabilization of polyalkylene carbonate polyols. The polyalkylene carbonate polyols disclosed in U.S. Pat. No. 4,145,525 contain alternating units of alkylene oxide and carbon dioxide. U.S. Pat. No. 4,145,525 teaches reacting at least some of the terminal hydroxyl groups of the polyalkylene carbonate polyol with a phosphorus compound reactive toward hydroxyl groups to form an oxygen-phosphorus compound. U.S. Pat. No. 4,145,525 does not disclose polyether carbonate polyols. However, the person skilled in the art does not receive any teaching from U.S. Pat. No. 4,145,525 as to how polyether carbonate polyols with a minimum content of cyclic carbonate can be prepared after thermal stress.

US 2003/134740 A1 discloses a process for preparing supported catalysts for copolymerization of carbon dioxide and epoxides, which serves for preparation of poly(alkylene carbonates), comprising the step of applying a zinc dicarboxylate to silicon dioxide. The process thus differs at least in the catalysts used, and even with regard to the quality of the carbon dioxide used the person skilled in the art is unable to infer the teaching of the invention.

WO 2015/059068 A1 discloses a process for preparing polyether carbonate polyols by catalytic copolymerization of carbon dioxide with alkylene oxides in the presence of one or more H-functional starter substances, although the advantageous use of particular qualities of carbon dioxide is not disclosed.

### SUMMARY

Since propylene carbonate has an exceptionally high boiling point of 240° C. at standard pressure, the separation thereof from the reaction mixture is costly and time-consuming. It is therefore desirable to develop a process for copolymerization of epoxides with carbon dioxide, wherein minimum amounts of cyclic carbonate (for example propylene carbonate) are formed. It was therefore an object of the present invention to provide a process by which polyether carbonate polyols can be prepared with improved selectivity (i.e. minimum ratio of cyclic carbonate to linear polyether carbonate polyol). Furthermore, it is an object of a preferred embodiment of the invention that, even after thermal stress on the polyether carbonate polyol, the latter has a minimum content of cyclic carbonate.

It has now been found that, surprisingly, the above-stated object is achieved by a process for preparing polyether carbonate polyols from H-functional starter substance, alkylene oxide and carbon dioxide in the presence of a DMC catalyst or in the presence of a metal complex catalyst based on the metals zinc and/or cobalt, wherein the carbon dioxide used has a purity of 99.5000% to 99.9449% by volume, preferably of 99.9000% to 99.9449% by volume.

In a preferred embodiment, the invention relates to a process for preparing polyether carbonate polyols from H-functional starter substance, alkylene oxide and carbon dioxide in the presence of a DMC catalyst or in the presence of a metal complex catalyst based on the metals zinc and/or cobalt, wherein the carbon dioxide used has a purity of 99.5000% to 99.9449% by volume, preferably of 99.9000% to 99.9449% by volume, and wherein
(α) optionally a portion of the H-functional starter substance and/or suspension medium containing no H-functional groups is initially charged in a reactor, in each case optionally together with DMC catalyst (“drying”),
(β) a portion of alkylene oxide is optionally added to the mixture from step (α) at temperatures of 90 to 150° C., and then the addition of the alkylene oxide is stopped (“activation”),
(γ) alkylene oxide and carbon dioxide are added onto an H-functional starter substance in a reactor in the presence of a double metal cyanide catalyst or in the presence of a metal complex catalyst based on the metals zinc and/or cobalt to obtain a reaction mixture comprising the polyether carbonate polyol (“copolymerization”),
(δ) the reaction mixture obtained in step (γ) optionally remains in the reactor or is optionally transferred continuously into a postreactor, with reduction in the free alkylene oxide content in the reaction mixture in each case by way of a postreaction.

### DETAILED DESCRIPTION

The carbon dioxide used in the process of the invention comprises, for example, components such as water, ammonia, oxygen, nitrogen oxides (NO, NO₂), hydrocarbons (benzene, toluene, xylene), acetaldehyde, carbon monoxide, methanol, sulfur dioxide, hydrogen sulfide and/or mercaptans. The nature and amount of the components present in the carbon dioxide depends on the process for producing the carbon dioxide. It has been found that, surprisingly, in the process of the invention for preparing polyether carbonate polyols, an improved selectivity (i.e. minimum ratio of cyclic carbonate to linear polyether carbonate polyol) is achieved when carbon dioxide of a lower purity is used, i.e. the proportion especially of the aforementioned components in the carbon dioxide is sufficiently high that the carbon dioxide used has a purity of 99.5000% to 99.9449% by volume, preferably of 99.9000% to 99.9449% by volume. A purity of the carbon dioxide of, for example, 99.9449% by volume should be understood such that the carbon dioxide used consists to an extent of 99.9449% by volume of carbon dioxide and to an extent of 0.0551% by volume of components such as, in particular, water, ammonia, oxygen, nitrogen oxides (NO, NO₂), hydrocarbons (benzene, toluene, xylene), acetaldehyde, carbon monoxide, methanol, sulfur dioxide, hydrogen sulfide and/or mercaptans.

A characteristic feature of the polyether carbonate polyols prepared in the presence of a double metal cyanide (DMC) catalyst in accordance with the invention is that they also contain ether groups between the carbonate groups. In relation to formula (Ia), this means that the ratio of e/f is preferably from 2:1 to 1:20, more preferably from 1.5:1 to 1:10.

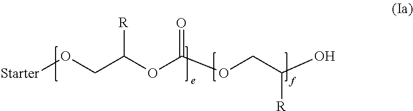

### Step (α):

The process of the invention for preparing polyether carbonate polyols by addition of alkylene oxides and carbon dioxide onto H-functional starter substance may comprise step (α) especially when the process is conducted in the presence of a double metal cyanide (DMC) catalyst.

In the process of the invention, it is possible first to initially charge the reactor with H-functional starter substance and/or a suspension medium containing no H-functional groups, preference being given to initially charging a portion of the H-functional starter substance. Subsequently, the amount of DMC catalyst required for the polyaddition, which is preferably unactivated, is introduced into the reactor. The sequence of addition is not crucial. It is also possible first to introduce the DMC catalyst and then the suspension medium into the reactor. Alternatively, it is also possible first to suspend the DMC catalyst in the inert suspension medium and then to introduce the suspension into the reactor. The suspension medium provides a sufficient heat transfer area with the reactor wall or cooling elements installed in the reactor, such that the heat of reaction released can be removed very efficiently. Moreover, the suspension medium, in the event of a cooling failure, provides heat capacity, such that the temperature in this case can be kept below the breakdown temperature of the reaction mixture.

The suspension media used in accordance with the invention do not contain any H-functional groups. Suitable suspension media are all polar aprotic, weakly polar aprotic and nonpolar aprotic solvents, none of which contain any H-functional groups. The suspension medium used may also be a mixture of two or more of these suspension media. Mention is made by way of example at this point of the following polar aprotic solvents: 4-methyl-2-oxo-1,3-dioxolane (also referred to hereinafter as cyclic propylene carbonate or cPC), 1,3-dioxolan-2-one (also referred to hereinafter as cyclic ethylene carbonate or cEC), acetone, methyl ethyl ketone, acetonitrile, nitromethane, dimethyl sulfoxide, sulfolane, dimethylformamide, dimethylacetamide and N-methylpyrrolidone. The group of the nonpolar and weakly polar aprotic solvents includes, for example, ethers, for example dioxane, diethyl ether, methyl tert-butyl ether and tetrahydrofuran, esters, for example ethyl acetate and butyl acetate, hydrocarbons, for example pentane, n-hexane, benzene and alkylated benzene derivatives (e.g. toluene, xylene, ethylbenzene) and chlorinated hydrocarbons, for example chloroform, chlorobenzene, dichlorobenzene and carbon tetrachloride. Preferred suspension media used are 4-methyl-2-oxo-1,3-dioxolane, 1,3-dioxolan-2-one, toluene, xylene, ethylbenzene, chlorobenzene and dichlorobenzene, and mixtures of two or more of these suspension media; particular preference is given to 4-methyl-2-oxo-1,3-dioxolane and 1,3-dioxolan-2-one or a mixture of 4-methyl-2-oxo-1,3-dioxolane and 1,3-dioxolan-2-one.

Likewise suitable as suspension media used in accordance with the invention are aliphatic lactones, aromatic lactones, lactides, cyclic carbonates having at least three optionally substituted methylene groups between the oxygen atoms of the carbonate group, aliphatic cyclic anhydrides and aromatic cyclic anhydrides.

Aliphatic or aromatic lactones in the context of the invention are cyclic compounds containing an ester bond in the ring, preferably

4-membered lactone rings such as β-propiolactone, β-butyrolactone, β-isovalerolactone, β-caprolactone, β-isocaprolactone, β-methyl-β-valerolactone,

5-membered lactone rings such as γ-butyrolactone, γ-valerolactone, 5-methylfuran-2(3H)-one, 5-methylidenedihydrofuran-2(3H)-one, 5-hydroxyfuran-2(5H)-one, 2-benzofuran-1(3H)-one and 6-methyl-2-benzofuran-1(3H)-one,

6-membered lactone rings such as δ-valerolactone, 1,4-dioxan-2-one, dihydrocoumarin, 1H-isochromen-1-one, 8H-pyrano[3,4-b]pyridin-8-one, 1,4-dihydro-3H-isochromen-3-one, 7,8-dihydro-5H-pyrano[4,3-b]pyridin-5-one, 4-methyl-3,4-dihydro-1H-pyrano[3,4-b]pyridin-1-one, 6-hydroxy-3,4-dihydro-1H-isochromen-1-one, 7-hydroxy-3,4-dihydro-2H-chromen-2-one, 3-ethyl-1H-isochromen-1-one, 3-(hydroxymethyl)-1H-isochromen-1-one, 9-hydroxy-1H,3H-benzo[de]isochromen-1-one, 6,7-dimethoxy-1,4-dihydro-3H-isochromen-3-one and 3-phenyl-3,4-dihydro-1H-isochromen-1-one,

7-membered lactone rings such as ε-caprolactone, 1,5-dioxepan-2-one, 5-methyloxepan-2-one, oxepane-2,7-dione, thiepan-2-one, 5-chlorooxepan-2-one, (4S)-4-(propan-2-yl)oxepan-2-one, 7-butyloxepan-2-one, 5-(4-aminobutyl)oxepan-2-one, 5-phenyloxepan-2-one, 7-hexyloxepan-2-one, (5S,7S)-5-methyl-7-(propan-2-yl)oxepan-2-one, 4-methyl-7-(propan-2-yl)oxepan-2-one,

higher-membered lactone rings such as (7E)-oxacycloheptadec-7-en-2-one.

Particular preference is given to ε-caprolactone and dihydrocoumarin.

Lactides in the context of the invention are cyclic compounds containing two or more ester bonds in the ring, preferably glycolide (1,4-dioxane-2,5-dione), L-lactide (L-3,6-dimethyl-1,4-dioxane-2,5-dione), D-lactide, DL-lactide, mesolactide and 3-methyl-1,4-dioxane-2,5-dione, 3-hexyl-6-methyl-1,4-dioxane-2,5-dione, 3,6-di(but-3-en-1-yl)-1,4-dioxane-2,5-dione (in each case including optically active forms). Particular preference is given to L-lactide.

Cyclic carbonates having at least three optionally substituted methylene groups between the oxygen atoms of the carbonate group are preferably trimethylene carbonate, neopentyl glycol carbonate (5,5-dimethyl-1,3-dioxan-2-one), 2,2,4-trimethylpentane-1,3-diol carbonate, 2,2-dimethylbutane-1,3-diol carbonate, butane-1,3-diol carbonate, 2-methylpropane-1,3-diol carbonate, pentane-2,4-diol carbonate, 2-methylbutane-1,3-diol carbonate, TMP monoallyl ether carbonate, pentaerythritol diallyl ether carbonate, 5-(2-hydroxyethyl)-1,3-dioxan-2-one, 5-[2-(benzyloxy)ethyl]-1,3-dioxan-2-one, 4-ethyl-1,3-dioxolan-2-one, 1,3-dioxolan-2-one, 5-ethyl-5-methyl-1,3-dioxan-2-one, 5,5-diethyl-1,3-di oxan-2-one, 5-methyl-5-propyl-1,3-dioxan-2-one, 5-(phenyl amino)-1,3-dioxan-2-one and 5,5-dipropyl-1,3-dioxan-2-one. Particular preference is given to trimethylene carbonate and neopentyl glycol carbonate.

Cyclic anhydrides are preferably succinic anhydride, maleic anhydride, phthalic anhydride, cyclohexane-1,2-dicarboxylic anhydride, diphenic anhydride, tetrahydrophthalic anhydride, methyltetrahydrophthalic anhydride, norbornenedioic anhydride and chlorination products thereof, succinic anhydride, glutaric anhydride, diglycolic anhydride, 1,8-naphthalic anhydride, succinic anhydride, dodecenylsuccinic anhydride, tetradecenylsuccinic anhydride, hexadecenylsuccinic anhydride, octadecenylsuccinic anhydride, 3- and 4-nitrophthalic anhydride, tetrachlorophthalic anhydride, tetrabromophthalic anhydride, itaconic anhydride, dimethylmaleic anhydride, allylnorbornenedioic anhydride, 3-methylfuran-2,5-dione, 3-methyldihydrofuran-2,5-dione, dihydro-2H-pyran-2,6(3H)-dione, 1,4-dioxane-2,6-dione, 2H-pyran-2,4,6(3H,5H)-trione, 3-ethyldihydrofuran-2,5-dione, 3-methoxydihydrofuran-2,5-dione, 3-(prop-2-en-1-yl)dihydrofuran-2,5-dione, N-(2,5-dioxotetrahydrofuran-3-yl)formamide and 3[(2E)-but-2-en-1-yl]dihydrofuran-2,5-dione. Particular preference is given to succinic anhydride, maleic anhydride and phthalic anhydride.

The suspension medium used may also be a mixture of two or more of the suspension media mentioned. Most preferably, the suspension medium used in step (α) is at least one compound selected from the group consisting of 4-methyl-2-oxo-1,3-dioxolane, 1,3-dioxolan-2-one, acetone, methyl ethyl ketone, acetonitrile, nitromethane, dimethyl sulfoxide, sulfolane, dimethylformamide, dimethylacetamide, N-methylpyrrolidone, dioxane, diethyl ether, methyl tert-butyl ether, tetrahydrofuran, ethyl acetate, butyl acetate, pentane, n-hexane, benzene, toluene, xylene, ethylbenzene, chloroform, chlorobenzene, dichlorobenzene, carbon tetrachloride, ε-caprolactone, dihydrocoumarin, trimethylene carbonate, neopentyl glycol carbonate, 3,6-dimethyl-1,4-dioxane-2,5-dione, succinic anhydride, maleic anhydride and phthalic anhydride.

In one embodiment of the invention, in step (α), a suspension medium containing no H-functional groups is initially charged in the reactor, optionally together with DMC catalyst, without including any H-functional starter substance in the initial reactor charge. Alternatively, it is also possible in step (α) to initially charge the reactor with a suspension medium containing no H-functional groups, and additionally a portion of the H-functional starter substance(s) and optionally DMC catalyst.

The DMC catalyst is preferably used in an amount such that the content of DMC catalyst in the reaction product resulting after step (γ) is 10 to 10 000 ppm, more preferably 20 to 5000 ppm and most preferably 50 to 500 ppm.

In a preferred embodiment, in step (α), inert gas (for example argon or nitrogen), an inert gas/carbon dioxide mixture or carbon dioxide is introduced into the resulting mixture (i) of a portion of the H-functional starter substance and/or suspension medium and (ii) DMC catalyst at a temperature of 90° C. to 150° C., more preferably of 100° C. to 140° C., and at the same time a reduced pressure (absolute) of 10 mbar to 800 mbar, more preferably of 50 mbar to 200 mbar, is applied.

In an alternative preferred embodiment, in step (α), the resulting mixture (i) of a portion of the H-functional starter substance(s) and/or suspension medium and (ii) DMC catalyst is contacted at least once, preferably three times, at a temperature of 90° C. to 150° C., more preferably of 100° C. to 140° C., with 1.5 bar to 10 bar (absolute), more preferably 3 bar to 6 bar (absolute), of an inert gas (for example argon or nitrogen), an inert gas/carbon dioxide mixture or carbon dioxide and then the positive pressure is reduced in each case to about 1 bar (absolute).

The DMC catalyst can be added in solid form or as a suspension in a suspension medium or in a mixture of at least two suspension media.

In a further preferred embodiment, in step (α),
(α-I) a portion of the H-functional starter substance and/or suspension medium is initially charged and
(α-II) the temperature of the portion of the H-functional starter substance and/or the suspension medium is brought to 50 to 200° C., preferably 80 to 160° C., more preferably 100 to 140° C., and/or the pressure in the reactor is lowered to less than 500 mbar, preferably 5 mbar to 100 mbar, in the course of which an inert gas stream (for example of argon or nitrogen), an inert gas/carbon dioxide stream or a carbon dioxide stream is optionally passed through the reactor,

wherein the double metal cyanide catalyst is added to the portion of the H-functional starter substance and/or suspension medium in step (α-I) or immediately thereafter in step (α-II), and wherein the suspension medium does not contain any H-functional groups.

### Step (β):

Step (β) serves to activate the DMC catalyst and thus relates to the embodiment of the process of the invention in the presence of a DMC catalyst. This step (β) is preferably conducted under a carbon dioxide atmosphere. Activation in the context of this invention refers to a step in which a portion of alkylene oxide is added to the DMC catalyst suspension at temperatures of 90° C. to 150° C. and then the addition of the alkylene oxide is stopped, with observation of evolution of heat caused by a subsequent exothermic chemical reaction, which can lead to a temperature spike (“hotspot”), and of a pressure drop in the reactor caused by the conversion of alkylene oxide and possibly CO₂. The process step of activation is the period of time from the addition of the portion of alkylene oxide, optionally in the presence of CO₂, to the DMC catalyst until the occurrence of the evolution of heat. Optionally, the portion of the alkylene oxide can be added to the DMC catalyst in a plurality of individual steps, optionally in the presence of CO₂, and then the addition of the alkylene oxide can be stopped in each case. In this case, the process step of activation comprises the period from the addition of the first portion of alkylene oxide, optionally in the presence of CO₂, to the DMC catalyst until the occurrence of the evolution of heat after addition of the last portion of alkylene oxide. In general, the activation step may be preceded by a step for drying the DMC catalyst and optionally the H-functional starter substance at elevated temperature and/or reduced pressure, optionally with passage of an inert gas through the reaction mixture.

The metered addition of one or more alkylene oxides (and optionally of the carbon dioxide) can in principle be effected in different ways. The metered addition can be started from the reduced pressure or at a preselected supply pressure. The supply pressure is preferably established by introduction of carbon dioxide, where the pressure (in absolute terms) is 5 mbar to 100 bar, preferably 10 mbar to 50 bar and more preferably 20 mbar to 50 bar.

In a preferred embodiment, the amount of one or more alkylene oxides used in the activation in step (β) is 0.1% to 25.0% by weight, preferably 1.0% to 20.0% by weight, more preferably 2.0% to 16.0% by weight (based on the amount of suspension medium used in step (α)). The alkylene oxide can be added in one step or in two or more portions. Preferably, addition of a portion of the alkylene oxide is followed by interruption of the addition of the alkylene oxide until the occurrence of evolution of heat, and only then is the next portion of alkylene oxide added.

### Step (γ):

The metered addition of the carbon dioxide, the alkylene oxide and optionally also of the H-functional starter substance can be effected simultaneously or sequentially (in portions); for example, it is possible to add the total amount of carbon dioxide, the amount of H-functional starter substances and/or the amount of alkylene oxides metered in step (γ) all at once or continuously. It should be taken into account here that H-functional starter substance is used at least in one of steps (α) and (γ). The term “continuous” as used here can be defined as a mode of addition of a reactant such that a concentration of the reactant effective for the copolymerization is maintained, meaning that, for example, the metered addition can be effected with a constant metering rate, with a varying metering rate or in portions.

It is possible, during the addition of the alkylene oxide and/or the H-functional starter substances, to increase or lower the CO₂ pressure gradually or stepwise or to leave it constant.

Preferably, the total pressure is kept constant during the reaction by replenishment of carbon dioxide. The metered addition of alkylene oxide and/or of H-functional starter substance is effected simultaneously or sequentially with respect to the metered addition of carbon dioxide. It is possible to meter in the alkylene oxide with a constant metering rate or to increase or lower the metering rate gradually or stepwise or to add the alkylene oxide in portions. Preferably, the alkylene oxide is added to the reaction mixture at a constant metering rate. If two or more alkylene oxides are used for synthesis of the polyether carbonate polyols, the alkylene oxides can be metered in individually or as a mixture. The metered addition of the alkylene oxides or the H-functional starter substances can be effected simultaneously or sequentially (in portions) via separate feeds (additions) in each case or via one or more feeds, in which case the alkylene oxide or the H-functional starter substances can be metered in individually or as a mixture. It is possible via the manner and/or sequence of the metered addition of the H-functional starter substances, the alkylene oxides and/or the carbon dioxide to synthesize random, alternating, block or gradient polyether carbonate polyols.

In a preferred embodiment, in step (γ), the metered addition of the H-functional starter substance is terminated at a juncture prior to the addition of the alkylene oxide.

Preference is given to using an excess of carbon dioxide based on the calculated amount of carbon dioxide incorporated in the polyether carbonate polyol, since an excess of carbon dioxide is advantageous because of the inertness of carbon dioxide. The amount of carbon dioxide can be fixed via the total pressure (in absolute terms) (in the context of the invention, the total pressure (in absolute terms) is defined as the sum total of the partial pressures of the alkylene oxide and carbon dioxide used) under the particular reaction conditions. An advantageous total pressure (in absolute terms) for the copolymerization for preparation of the polyether carbonate polyols has been found to be in the range from 5 to 120 bar, preferably 10 to 110 bar, more preferably from 20 to 100 bar. It is possible to feed in the carbon dioxide continuously or discontinuously. This depends on how quickly the alkylene oxides are consumed and whether the product is supposed to contain any CO₂-free polyether blocks. The amount of the carbon dioxide (reported as pressure) can likewise vary in the course of addition of the alkylene oxides. CO₂ may also be added to the reactor as a solid and then converted to the gaseous, dissolved, liquid and/or supercritical state under the chosen reaction conditions.

One feature of a preferred embodiment of the process of the invention is that in step (γ) the total amount of the H-functional starter substance is added. This addition can be effected at a constant metering rate, with a varying metering rate, or in portions.

For the process of the invention, it has additionally been found that the copolymerization (step (γ)) for preparation of the polyether carbonate polyols is conducted advantageously at 50° C. to 150° C., preferably at 60° C. to 145° C., more preferably at 70° C. to 140° C. and most preferably at 90° C. to 130° C. If temperatures below 50° C. are set, the reaction generally becomes very slow. At temperatures above 150° C., the amount of unwanted by-products rises significantly.

The metered addition of the alkylene oxide, the H-functional starter substance and the DMC catalyst can be effected via separate or combined metering points. In a preferred embodiment, the alkylene oxide and the H-functional starter substance are metered continuously into the reaction mixture via separate metering points. This addition of the H-functional starter substance can be effected in the form of a continuous metered addition to the reactor or in portions.

Steps (α), (β) and (γ) can be conducted in the same reactor or each separately in different reactors. Particularly preferred reactor types are: tubular reactors, stirred tanks, loop reactors.

Polyether carbonate polyols can be prepared in a stirred tank, in which case the stirred tank, according to the embodiment and mode of operation, is cooled via the reactor jacket, internal cooling surfaces and/or cooling surfaces within a pumped circulation system. Both in semi-batchwise application, in which the product is not removed until after the end of the reaction, and in continuous application, in which the product is removed continuously, particular attention should be paid to the metering rate of the alkylene oxide. It should be adjusted such that the alkylene oxides react sufficiently rapidly despite the inhibiting effect of the carbon dioxide. The concentration of free alkylene oxides in the reaction mixture during the activation step (step β) is preferably >0% to 100% by weight, more preferably >0% to 50% by weight, most preferably >0% to 20% by weight (based in each case on the weight of the reaction mixture). The concentration of free alkylene oxides in the reaction mixture during the reaction (step γ) is preferably >0% to 40% by weight, more preferably >0% to 25% by weight, most preferably >0% to 15% by weight (based in each case on the weight of the reaction mixture).

In a preferred embodiment, the mixture comprising activated DMC catalyst that results from steps (α) and (β) is reacted further in the same reactor with one or more alkylene oxide(s), one or more starter substance(s) and carbon dioxide. In a further preferred embodiment, the mixture comprising activated DMC catalyst that results from steps (α) and (β) is reacted further with alkylene oxides, one or more starter substance(s) and carbon dioxide in another reaction vessel (for example a stirred tank, tubular reactor or loop reactor).

In the case of a reaction conducted in a tubular reactor, the mixture comprising activated DMC catalyst that results from steps (α) and (β), one or more H-functional starter substance(s), one or more alkylene oxide(s) and carbon dioxide are pumped continuously through a tube. The molar ratios of the co-reactants vary according to the desired polymer. In a preferred embodiment carbon dioxide is metered in its liquid or supercritical form to achieve optimal miscibility of the components. It is advantageous to install mixing elements for better mixing of the co-reactants as are marketed for example by Ehrfeld Mikrotechnik BTS GmbH or mixer-heat exchanger elements which simultaneously improve mixing and heat removal.

Loop reactors can likewise be used for preparation of polyether carbonate polyols. These generally include reactors having recycling of matter, for example a jet loop reactor, which can also be operated continuously, or a tubular reactor designed in the form of a loop with suitable apparatuses for the circulation of the reaction mixture, or a loop of several series-connected tubular reactors. The use of a loop reactor is advantageous especially because backmixing can be achieved here, such that it is possible to keep the concentration of free alkylene oxides in the reaction mixture within the optimal range, preferably in the range from >0% to 40% by weight, more preferably >0% to 25% by weight, most preferably >0% to 15% by weight (based in each case on the weight of the reaction mixture).

Preferably, the polyether carbonate polyols are prepared in a continuous process which comprises both a continuous copolymerization and a continuous addition of the one or more H-functional starter substance(s).

The invention therefore also provides a process wherein, in step (γ), H-functional starter substance, alkylene oxide and DMC catalyst are metered continuously into the reactor in the presence of carbon dioxide (“copolymerization”) and wherein the resulting reaction mixture (comprising the reaction product) is removed continuously from the reactor. Preferably, in step (γ), the DMC catalyst is added continuously in suspension in H-functional starter substance.

For example, for the continuous process for preparing the polyether carbonate polyols in steps (α) and (β), a mixture containing activated DMC catalyst is prepared, then, in step (γ),
(γ1) a portion each of H-functional starter substance, alkylene oxide and carbon dioxide are metered in to initiate the copolymerization, and
(γ2) during the progress of the copolymerization, the remaining amount of each of DMC catalyst, H-functional starter substance and alkylene oxide is metered in continuously in the presence of carbon dioxide, with simultaneous continuous removal of resulting reaction mixture from the reactor.

In step (γ), the DMC catalyst is preferably added in a suspension in the H-functional starter substance, the amount preferably being chosen such that the content of DMC catalyst in the reaction product resulting in step (γ) is 10 to 10 000 ppm, more preferably 20 to 5000 ppm and most preferably 50 to 500 ppm.

Preferably, steps (α) and (β) are conducted in a first reactor, and the resulting reaction mixture is then transferred into a second reactor for the copolymerization in step (γ). It is also possible to conduct steps (α), (β) and (γ) in one reactor.

It has also been found that, surprisingly, the process of the present invention can be used for preparation of large amounts of the polyether carbonate polyol, in which case a DMC catalyst activated according to steps (α) and (β) in a portion of the H-functional starter substance and/or in suspension medium is initially used, and the DMC catalyst is added without prior activation during the copolymerization (γ).

A particularly advantageous feature of the preferred embodiment of the present invention is thus the ability to use “fresh” DMC catalysts without activation of the portion of DMC catalyst which is added continuously in step (γ). An activation of DMC catalysts to be conducted analogously to step (β) encompasses not just additional attention from the operator, which results in an increase in manufacturing costs, but also requires a pressure reaction vessel, which also results in an increase in the capital costs in the construction of a corresponding production plant. Here, “fresh” DMC catalyst is defined as unactivated DMC catalyst in solid form or in the form of a slurry in H-functional starter substance or in suspension medium. The ability of the present process to use fresh unactivated DMC catalyst in step (γ) enables significant savings in the commercial preparation of polyether carbonate polyols and is a preferred embodiment of the present invention.

The term “continuously” used here can be defined as the mode of addition of a relevant catalyst or reactant such that an essentially continuous effective concentration of the DMC catalyst or the reactant is maintained. The catalysts can be fed in a truly continuous manner or in relatively tightly spaced increments. Equally, continuous addition of starter can be effected in a truly continuous manner or in increments. There would be no departure from the present process in adding a DMC catalyst or reactants incrementally such that the concentration of the materials added drops essentially to zero for a period prior to the next incremental addition. However, it is preferable that the DMC catalyst concentration is kept essentially at the same concentration during the main portion of the procedure of the continuous reaction, and that starter substance is present during the main portion of the copolymerization process. Incremental addition of DMC catalyst and/or reactant that does not significantly affect the characteristics of the product is nevertheless “continuous” in that sense in which the term is used here. It is possible, for example, to provide a recycling loop in which a portion of the reacting mixture is recycled to a prior point in the process, which smoothes out discontinuities caused by incremental additions.

### Step (δ)

In the optional step (δ), the reaction mixture obtained in step (γ), generally containing a content of 0.05% by weight to 10% by weight of alkylene oxide, can be subjected to a postreaction in the reactor or can be continuously transferred into a postreactor for postreaction, with reduction of the free alkylene oxide content by way of postreaction. In step (δ), by way of postreaction, the free alkylene oxide content is preferably reduced to less than 0.5 g/l, more preferably to less than 0.1 g/l, in the reaction mixture.

When the reaction mixture obtained in step (γ) remains in the reactor, the reaction mixture is preferably kept at a temperature of 60° C. to 140° C. for 10 min to 24 h, more preferably at a temperature of 80° C. to 130° C. for 1 h to 12 h, for postreaction. The reaction mixture is preferably stirred for this period until the free alkylene oxide content has fallen to less than 0.5 g/l, more preferably to less than 0.1 g/l, in the reaction mixture. The consumption of free alkylene oxide and optionally carbon dioxide generally causes the pressure in the reactor to fall during the postreaction in step (δ) until a constant value has been achieved.

The postreactor used may, for example, be a tubular reactor, a loop reactor or a stirred tank. Preferably, the pressure in this postreactor is at the same pressure as in the reaction apparatus in which reaction step (γ) is conducted. The pressure in the downstream reactor can, however, also be selected at a higher or lower level. In a further preferred embodiment, the carbon dioxide, after reaction step (γ), is fully or partly released and the downstream reactor is operated at standard pressure or a slightly elevated pressure. The temperature in the downstream reactor is preferably 50° C. to 150° C. and more preferably 80° C. to 140° C.

The postreactor employed is preferably a tubular reactor, wherein for example a single tubular reactor or else a cascade of a plurality of tubular reactors arranged in parallel or linearly arranged in series may be used. The residence time in the tubular reactor is preferably between 5 min and 10 h, more preferably between 10 min and 5 h.

DMC catalysts for use in the homopolymerization of alkylene oxides are known in principle from the prior art (see, for example, U.S. Pat. Nos. 3,404,109, 3,829,505, 3,941,849 and 5,158,922). DMC catalysts, which are described, for example, in U.S. Pat. No. 5,470,813, EP-A 700 949, EP-A 743 093, EP-A 761 708, WO 97/40086, WO 98/16310 and WO 00/47649, have a very high activity and enable the preparation of polyether carbonate polyols at very low catalyst concentrations, such that a removal of the catalyst from the finished product is generally not required. A typical example is that of the highly active DMC catalysts which are described in EP-A 700 949 and contain not only a double metal cyanide compound (e.g. zinc hexacyanocobaltate(III)) and an organic complex ligand (e.g. tert-butanol) but also a polyether having a number-average molecular weight greater than 500 g/mol.

The DMC catalysts are preferably obtained by
(i) reacting an aqueous solution of a metal salt with the aqueous solution of a metal cyanide salt in the presence of one or more organic complex ligands, e.g. an ether or alcohol, in a first step,
(ii) in the second step separating the solids from the suspension obtained in (i) by known techniques (such as centrifugation or filtration),
(iii) in a third step optionally washing the isolated solids with an aqueous solution of an organic complex ligand (for example by resuspension and subsequently reisolation by filtration or centrifugation),
(iv) then drying the solids obtained at temperatures of generally 20-120° C. and at pressures of generally 0.1 mbar to standard pressure (1013 mbar), optionally after pulverizing,

and by, in the first step or immediately after the precipitation of the double metal cyanide compound (second step), adding one or more organic complex ligands, preferably in excess (based on the double metal cyanide compound) and optionally further complex-forming components.

The double metal cyanide compounds present in the DMC catalysts are the reaction products of water-soluble metal salts and water-soluble metal cyanide salts.

For example, an aqueous solution of zinc chloride (preferably in excess based on the metal cyanide salt, for example potassium hexacyanocobaltate) and potassium hexacyanocobaltate are mixed and dimethoxyethane (glyme) or tert-butanol (preferably in excess based on zinc hexacyanocobaltate) is then added to the suspension formed.

Metal salts suitable for preparation of the double metal cyanide compounds preferably have the general formula (II)

M(X)ₙ (II)

where

M is selected from the metal cations Zn²⁺, Fe²⁺, Ni²⁺, Mn²⁺, Co²⁺, Sr²⁺, Sn²⁺, Pb²⁺ and Cu²⁺; M is preferably Zn²⁺, Fe²⁺, Co²⁺ or Ni²⁺,

X are one or more (i.e. different) anions, preferably an anion selected from the group of the halides (i.e. fluoride, chloride, bromide, iodide), hydroxide, sulfate, carbonate, cyanate, thiocyanate, isocyanate, isothiocyanate, carboxylate, oxalate and nitrate;

n is 1 when X=sulfate, carbonate or oxalate and

n is 2 when X=halide, hydroxide, carboxylate, cyanate, thiocyanate, isocyanate, isothiocyanate or nitrate,

or suitable metal salts have the general formula (III)

Mᵣ(X)₃ (III)

where

M is selected from the metal cations Fe³⁺, Al³⁺, Co³⁺ and Cr³⁺,

X are one or more (i.e. different) anions, preferably an anion selected from the group of the halides (i.e. fluoride, chloride, bromide, iodide), hydroxide, sulfate, carbonate, cyanate, thiocyanate, isocyanate, isothiocyanate, carboxylate, oxalate and nitrate;

r is 2 when X=sulfate, carbonate or oxalate and

r is 1 when X=halide, hydroxide, carboxylate, cyanate, thiocyanate, isocyanate, isothiocyanate or nitrate,

or suitable metal salts have the general formula (IV)

M(X)ₛ (IV)

where

M is selected from the metal cations Mo⁴⁺, V⁴⁺ and W⁴⁺,

X are one or more (i.e. different) anions, preferably an anion selected from the group of the halides (i.e. fluoride, chloride, bromide, iodide), hydroxide, sulfate, carbonate, cyanate, thiocyanate, isocyanate, isothiocyanate, carboxylate, oxalate and nitrate;

s is 2 when X=sulfate, carbonate or oxalate and

s is 4 when X=halide, hydroxide, carboxylate, cyanate, thiocyanate, isocyanate, isothiocyanate or nitrate,

or suitable metal salts have the general formula (V)

M(X)ₜ (V)

where

M is selected from the metal cations Mo⁶⁺ and W⁶⁺,

X are one or more (i.e. different) anions, preferably an anion selected from the group of the halides (i.e. fluoride, chloride, bromide, iodide), hydroxide, sulfate, carbonate, cyanate, thiocyanate, isocyanate, isothiocyanate, carboxylate, oxalate and nitrate;

t is 3 when X=sulfate, carbonate or oxalate and

t is 6 when X=halide, hydroxide, carboxylate, cyanate, thiocyanate, isocyanate, isothiocyanate or nitrate.

Examples of suitable metal salts are zinc chloride, zinc bromide, zinc iodide, zinc acetate, zinc acetylacetonate, zinc benzoate, zinc nitrate, iron(II) sulfate, iron(II) bromide, iron(II) chloride, iron(III) chloride, cobalt(II) chloride, cobalt(II) thiocyanate, nickel(II) chloride and nickel(II) nitrate. It is also possible to use mixtures of different metal salts.

Metal cyanide salts suitable for preparation of the double metal cyanide compounds preferably have the general formula (VI)

(Y)ₐM′(CN)_{b}(A)_{c} (VI)

where

M′ is selected from one or more metal cations from the group consisting of Fe(II), Fe(III), Co(II), Co(III), Cr(II), Cr(III), Mn(II), Mn(III), Ir(III), Ni(II), Rh(III), Ru(II), V(IV) and V(V); M′ is preferably one or more metal cations from the group consisting of Co(II), Co(III), Fe(II), Fe(III), Cr(III), Ir(III) and Ni(II),

Y is selected from one or more metal cations from the group consisting of alkali metal (i.e. Li⁺, Na⁺, K⁺, Rb⁺) and alkaline earth metal (i.e. Be²⁺, Mg²⁺, Ca²⁺, Sr²⁺, Ba²⁺),

A is selected from one or more anions from the group consisting of halides (i.e. fluoride, chloride, bromide, iodide), hydroxide, sulfate, carbonate, cyanate, thiocyanate, isocyanate, isothiocyanate, carboxylate, azide, oxalate or nitrate and

a, b and c are integers, where the values of a, b and c are selected so as to give an electrically neutral metal cyanide salt; a is preferably 1, 2, 3 or 4; b is preferably 4, 5 or 6; c preferably has the value of 0.

Examples of suitable metal cyanide salts are sodium hexacyanocobaltate(III), potassium hexacyanocobaltate(III), potassium hexacyanoferrate(II), potassium hexacyanoferrate(III), calcium hexacyanocobaltate(III) and lithium hexacyanocobaltate(III).

Preferred double metal cyanide compounds present in the DMC catalysts are compounds of the general formula (VII)

Mₓ[M′ₓ,(CN)_{y}]_{z} (VII)

in which M is defined as in formula (II) to (V) and

M′ is as defined in formula (VI), and

x, x′, y and z are integers and are chosen so as to give an electrically neutral double metal cyanide compound.

Preferably,

x=3, x′=1, y=6 and z=2,

M=Zn(II), Fe(II), Co(II) or Ni(II) and

M′=Co(III), Fe(III), Cr(III) or Ir(III).

Examples of suitable double metal cyanide compounds a) are zinc hexacyanocobaltate(III), zinc hexacyanoiridate(III), zinc hexacyanoferrate(III) and cobalt(II) hexacyanocobaltate(III). Further examples of suitable double metal cyanide compounds can be found, for example, in U.S. Pat. No. 5,158,922 (column 8, lines 29-66). Particular preference is given to using zinc hexacyanocobaltate(III).

The organic complex ligands added in the preparation of the DMC catalysts are disclosed, for example, in U.S. Pat. No. 5,158,922 (see especially column 6 lines 9 to 65), U.S. Pat. Nos. 3,404,109, 3,829,505, 3,941,849, EP-A 700 949, EP-A 761 708, JP 4 145 123, U.S. Pat. No. 5,470,813, EP-A 743 093 and WO-A 97/40086). The organic complex ligands used are, for example, water-soluble organic compounds containing heteroatoms such as oxygen, nitrogen, phosphorus or sulfur, which can form complexes with the double metal cyanide compound. Preferred organic complex ligands are alcohols, aldehydes, ketones, ethers, esters, amides, ureas, nitriles, sulfides and mixtures thereof. Particularly preferred organic complex ligands are aliphatic ethers (such as dimethoxyethane), water-soluble aliphatic alcohols (such as ethanol, isopropanol, n-butanol, isobutanol, sec-butanol, tert-butanol, 2-methyl-3-buten-2-ol and 2-methyl-3-Butyn-2-ol), compounds containing both aliphatic or cycloaliphatic ether groups and aliphatic hydroxyl groups (for example ethylene glycol mono-tert-butyl ether, diethylene glycol mono-tert-butyl ether, tripropylene glycol monomethyl ether and 3-methyl-3-oxetanemethanol). The organic complex ligands given greatest preference are selected from one or more compounds of the group consisting of dimethoxyethane, tert-butanol, 2-methyl-3-buten-2-ol, 2-methyl-3-Butyn-2-ol, ethylene glycol mono-tert-butyl ether and 3-methyl-3-oxetanemethanol.

Optionally used in the preparation of the DMC catalysts are one or more complex-forming component(s) from the compound classes of the polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkyl acrylates, polyalkyl methacrylates, polyvinyl methyl ethers, polyvinyl ethyl ethers, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid and maleic anhydride copolymers, hydroxyethyl cellulose and polyacetals, or of the glycidyl ethers, glycosides, carboxylic esters of polyhydric alcohols, gallic acids or salts, esters or amides thereof, cyclodextrins, phosphorus compounds, α,β-unsaturated carboxylic esters or ionic surface- or interface-active compounds.

Preferably, in the preparation of the DMC catalysts, in the first step, the aqueous solutions of the metal salt (e.g. zinc chloride), used in a stoichiometric excess (at least 50 mol %) based on metal cyanide salt (i.e. at least a molar ratio of metal salt to metal cyanide salt of 2.25:1.00), and of the metal cyanide salt (e.g. potassium hexacyanocobaltate) are converted in the presence of the organic complex ligand (e.g. tert-butanol), forming a suspension containing the double metal cyanide compound (e.g. zinc hexacyanocobaltate), water, excess metal salt and the organic complex ligand.

The organic complex ligand may be present in the aqueous solution of the metal salt and/or the metal cyanide salt, or it is added directly to the suspension obtained after precipitation of the double metal cyanide compound. It has been found to be advantageous to mix the aqueous solutions of the metal salt and the metal cyanide salt and the organic complex ligand with vigorous stirring. Optionally, the suspension formed in the first step is subsequently treated with a further complex-forming component. The complex-forming component is preferably used in a mixture with water and organic complex ligand. A preferred process for performing the first step (i.e. the preparation of the suspension) is effected using a mixing nozzle, more preferably using a jet disperser as described in WO-A 01/39883.

In the second step, the solids (i.e. the precursor of the catalyst of the invention) are isolated from the suspension by known techniques, such as centrifugation or filtration.

In a preferred variant, the isolated solids, in a third process step, are then washed with an aqueous solution of the organic complex ligand (for example by resuspension and subsequent reisolation by filtration or centrifugation). In this way, it is possible, for example, to remove water-soluble by-products, such as potassium chloride, from the catalyst. Preferably, the amount of the organic complex ligand in the aqueous wash solution is between 40% and 80% by weight, based on the overall solution.

Optionally, in the third step, further complex-forming component is added to the aqueous wash solution, preferably in the range between 0.5% and 5% by weight, based on the overall solution.

It is also advantageous to wash the isolated solids more than once. It is preferable when said solid is washed with an aqueous solution of the organic complex ligand (for example with an aqueous solution of the unsaturated alcohol) in a first wash step (iii-1) (for example by resuspension and subsequent reisolation by filtration or centrifugation), in order thus to remove, for example, water-soluble by-products such as potassium chloride from the catalyst. It is particularly preferable when the amount of the organic complex ligand (for example unsaturated alcohol) in the aqueous wash solution is between 40 and 80% by weight, based on the overall solution in the first wash step. In the further wash steps (iii-2) the first wash step is either repeated one or more times, preferably one to three times, or, preferably, a nonaqueous solution, for example a mixture or solution of organic complex ligands (for example unsaturated alcohol) and a further complex-forming component (preferably in the range between 0.5% and 5% by weight, based on the total amount of the wash solution in step (iii-2)), is used as a wash solution to wash the solid one or more times, preferably one to three times.

The isolated and possibly washed solid is subsequently dried at temperatures of in general 20-100° C. and at pressures of in general 0.1 mbar to atmospheric pressure (1013 mbar), optionally after pulverizing.

A preferred process for isolation of the DMC catalysts from the suspension by filtration, filtercake washing and drying is described in WO-A 01/80994.

After performance of the process of the invention for preparing the polyether carbonate polyol, the resulting reaction mixture generally comprises the DMC catalyst in the form of finely dispersed solid particles. It may therefore be desirable to remove as much as possible of the DMC catalyst from the resulting reaction mixture. The removal of the DMC catalyst has the advantage that the resulting polyether carbonate polyol achieves industry- or certification-relevant limits for example in terms of metal contents or in terms of other emissions resulting from activated catalyst remaining in the product and also facilitates recovery of the DMC catalyst.

The DMC catalyst may be removed very substantially or completely using various methods. The DMC catalyst can be separated from the polyether carbonate polyol, for example, using membrane filtration (nanofiltration, ultrafiltration or crossflow filtration), using cake filtration, using precoat filtration or by centrifugation.

Preferably, removal of the DMC catalyst is accomplished by a multistage process consisting of at least two steps.

For example, in a first step, the reaction mixture to be filtered is divided in a first filtration step into a larger substream (filtrate) in which a majority of the catalyst or all the catalyst has been removed, and a smaller residual stream (retentate) comprising the catalyst removed. In a second step, the residual stream is then subjected to a dead end filtration. This affords a further filtrate stream in which a majority of the catalyst or all the catalyst has been removed, and a damp to very substantially dry catalyst residue.

Alternatively, the catalyst present in the polyether carbonate polyol can be subjected in a first step to an adsorption, agglomeration/coagulation and/or flocculation, followed by, in a second step or a plurality of subsequent steps, the separation of the solid phase from the polyether carbonate polyol. Suitable adsorbents for mechanical-physical and/or chemical adsorption comprise, inter alia, activated or nonactivated aluminas and fuller's earths (sepiolite, montmorillonite, talc etc.), synthetic silicates, activated carbon, silicas/diatomaceous earths and activated silicas/diatomaceous earths in typical amount ranges of from 0.1% by weight to 2% by weight, preferably 0.8% by weight to 1.2% by weight, based on the polyether carbonate polyol at temperatures of from 60° C. to 140° C., preferably 90° C. to 110° C., and residence times of from 20 min to 100 min, preferably 40 min to 80 min, it being possible to carry out the adsorption step, including blending of the adsorbent, in batchwise or continuous fashion.

A preferred process for removing this solid phase (consisting, for example, of adsorbent and DMC catalyst) from the polyether carbonate polyol is precoat filtration. In this method, depending on the filtration characteristics, which are determined by the particle size distribution of the solid phase to be removed, by the mean specific resistance of the resulting filtercake and by the total resistance of the precoat layer and filtercake, the filter surface is coated with a permeable filtration aid (for example inorganic: Celite, perlite; organic: cellulose) having a layer thickness of 20 mm to 250 mm, preferably 100 mm to 200 mm (“precoat”). The majority of the solid phase (consisting, for example, of adsorbent and DMC catalyst) is removed at the surface of the precoat layer in combination with depth filtration of the smaller particles within the precoat layer. The temperature of the crude product to be filtered is in the range from 50° C. to 120° C., preferably 70° C. to 100° C.

In order to ensure a sufficient flow of product through the precoat layer and the cake layer growing thereon, the cake layer and a small part of the precoat layer may be removed (periodically or continuously) using a scraper or blade and removed from the process. This scraper/blade is moved at minimal advance rates of about 20 μm/min-500 μm/min, preferably in the range of 50 μm/min-150 μm/min.

As soon as the precoat layer has been very substantially or completely removed by this process, the filtration is stopped and a new precoat layer is applied to the filter surface. In this case, the filtration aid may be suspended, for example, in cyclic propylene carbonate.

This precoat filtration is typically conducted in vacuum drum filters. In order to achieve industrially relevant filtrate throughputs in the range from 0.1 m³/(m²·h) to 5 m³/(m²·h) in the case of a viscous feed stream, the drum filter may also be executed as a pressure drum filter with pressure differentials of up to 6 bar or more between the medium to be filtered and the filtrate side.

In principle, the DMC catalyst may be removed from the resulting reaction mixture in the process of the invention either before removal of volatile constituents (for example cyclic propylene carbonate) or after the removal of volatile constituents.

In addition, the separation of the DMC catalyst from the resulting reaction mixture from the process of the invention may be conducted with or without the further addition of a solvent (especially cyclic propylene carbonate) for the purpose of lowering the viscosity before or during the individual steps of catalyst removal described.

As well as the DMC catalysts based on zinc hexacyanocobaltate (Zn₃[Co(CN)₆]₂) that are used with preference, it is also possible to use other metal complex catalysts based on the metals zinc and/or cobalt that are known to those skilled in the art from the prior art for the copolymerization of epoxides and carbon dioxide for the process of the invention. This especially includes what are called zinc glutarate catalysts (described, for example, in M. H. Chisholm et al., Macromolecules 2002, 35, 6494), what are called zinc diiminate catalysts (described, for example, in S. D. Allen, J. Am. Chem. Soc. 2002, 124, 14284), what are called cobalt salen catalysts (described, for example, in U.S. Pat. No. 7,304,172 B2, US 2012/0165549 A1) and bimetallic zinc complexes with macrocyclic ligands (described, for example, in M. R. Kember et al., Angew. Chem., Int. Ed., 2009, 48, 931).

In general, it is possible to use alkylene oxides (epoxides) having 2-24 carbon atoms for the process of the invention. The alkylene oxides having 2-24 carbon atoms are, for example, one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C1-C24 esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkoxysilanes, for example 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. Preferably, the alkylene oxides used are 1-butene oxide, ethylene oxide and/or propylene oxide, in particular propylene oxide.

Suitable H-functional starter substances (“starters”) used may be compounds having alkoxylation-active hydrogen atoms and having a molar mass of 18 to 4500 g/mol, preferably of 62 to 500 g/mol and more preferably of 62 to 182 g/mol. The ability to use a starter having a low molar mass is a distinct advantage over the use of oligomeric starters prepared by means of a prior oxyalkylation. More particularly, economic viability is achieved, which is enabled by the omission of a separate oxyalkylation process.

Examples of alkoxylation-active groups having active H atoms include —OH, —NH2 (primary amines), —NH— (secondary amines), —SH, and —CO2H, preferably —OH and NH2, particularly preferably —OH. H-functional starter substances employed are, for example, one or more compounds selected from the group consisting of mono- and polyhydric alcohols, polyfunctional amines, polyfunctional thiols, amino alcohols, thio alcohols, hydroxy esters, polyether polyols, polyester polyols, polyester ether polyols, polyether carbonate polyols, polycarbonate polyols, polycarbonates, polyethyleneimines, polyetheramines, polytetrahydrofurans (e.g. PolyTHF® from BASF), polytetrahydrofuran amines, polyether thiols, polyacrylate polyols, castor oil, the mono- or diglyceride of ricinoleic acid, monoglycerides of fatty acids, chemically modified mono-, di- and/or triglycerides of fatty acids, and C1-C24 alkyl fatty acid esters containing an average of at least 2 OH groups per molecule. The C1-C24 alkyl fatty acid esters which contain on average at least 2 OH groups per molecule are, for example, commercial products such as Lupranol Balance® (BASF AG), Merginol® products (Hobum Oleochemicals GmbH), Sovermol® products (Cognis Deutschland GmbH & Co. KG), and Soyol® TM products (USSC Co.).

The mono-H-functional starter substances used may be alcohols, amines, thiols and carboxylic acids. Monofunctional alcohols used may be: methanol, ethanol, 1-propanol, 2-propanol, 1-butanol, 2-butanol, tert-butanol, 3-buten-1-ol, 3-Butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Useful monofunctional amines include: butylamine, t-butylamine, pentylamine, hexylamine, aniline, aziridine, pyrrolidine, piperidine, morpholine. Monofunctional thiols used may be: ethanethiol, propane-1-thiol, propane-2-thiol, butane-1-thiol, 3-methylbutane-1-thiol, 2-butene-1-thiol, thiophenol. Monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid.

Examples of polyhydric alcohols suitable as H-functional starter substances include dihydric alcohols (for example ethylene glycol, diethylene glycol, propylene glycol, dipropylene glycol, 1,3-propanediol, 1,4-butanediol, 1,4-butenediol, 1,4-butynediol, neopentyl glycol, 1,5-pentanediol, methylpentanediols (for example 3-methyl-1,5-pentanediol), 1,6-hexanediol, 1,8-octanediol, 1,10-decanediol, 1,12-dodecanediol, bis(hydroxymethyl)cyclohexanes (for example 1,4-bis(hydroxymethyl)cyclohexane), triethylene glycol, tetraethylene glycol, polyethylene glycols, dipropylene glycol, tripropylene glycol, polypropylene glycols, dibutylene glycol and polybutylene glycols); trihydric alcohols (for example trimethylolpropane, glycerol, trishydroxyethyl isocyanurate, castor oil); tetrahydric alcohols (for example pentaerythritol); polyalcohols (for example sorbitol, hexitol, sucrose, starch, starch hydrolyzates, cellulose, cellulose hydrolyzates, hydroxy-functionalized fats and oils, especially castor oil), and all the modification products of these aforementioned alcohols with different amounts of ε-caprolactone.

The H-functional starter substances may also be selected from the class of polyether polyols having a molecular weight Mn in the range from 18 to 4500 g/mol and a functionality of 2 to 3. Preference is given to polyether polyols formed from repeat ethylene oxide and propylene oxide units, preferably having a proportion of propylene oxide units of 35% to 100%, particularly preferably having a proportion of propylene oxide units of 50% to 100%. These may be random copolymers, gradient copolymers, alternating or block copolymers formed from ethylene oxide and propylene oxide.

The H-functional starter substances may also be selected from the class of polyester polyols. Polyester polyols used are at least difunctional polyesters. Polyester polyols preferably consist of alternating acid and alcohol units. Acid components used are, for example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the acids and/or anhydrides mentioned. Alcohol components used are, for example, ethanediol, propane-1,2-diol, propane-1,3-diol, butane-1,4-diol, pentane-1,5-diol, neopentyl glycol, hexane-1,6-diol, 1,4-bis(hydroxymethyl)cyclohexane, diethylene glycol, dipropylene glycol, trimethylolpropane, glycerol, pentaerythritol or mixtures of the alcohols mentioned. If the alcohol components used are dihydric or polyhydric polyether polyols, the result is polyester ether polyols which can likewise serve as starter substances for preparation of the polyether carbonate polyols.

In addition, the H-functional starter substances used may be polycarbonate diols which are prepared, for example, by reaction of phosgene, dimethyl carbonate, diethyl carbonate or diphenyl carbonate with difunctional alcohols or polyester polyols or polyether polyols. Examples of polycarbonates may be found, for example, in EP-A 1359177.

In a further embodiment of the invention, it is possible to use polyether carbonate polyols as H-functional starter substances. To this end, these polyether carbonate polyols used as H-functional starter substances are prepared in a separate reaction step beforehand.

The H-functional starter substances generally have a functionality (i.e. the number of polymerization-active hydrogen atoms per molecule) of 1 to 8, preferably of 2 or 3. The H-functional starter substances are used either individually or as a mixture of at least two H-functional starter substances.

It is particularly preferable when the H-functional starter substances are one or more compounds selected from the group consisting of ethylene glycol, propylene glycol, propane-1,3-diol, butane-1,3-diol, butane-1,4-diol, pentane-1,5-diol, 2-methylpropane-1,3-diol, neopentyl glycol, 1,6-hexanediol, 1,8-octanediol, diethylene glycol, dipropylene glycol, glycerol, trimethylolpropane, pentaerythritol, sorbitol and polyether polyols having a molecular weight Mn in the range from 150 to 4500 g/mol and a functionality of 2 to 3.

The polyether carbonate polyols are prepared by catalytic addition of carbon dioxide and alkylene oxides onto H-functional starter substances. “H-functional” in the context of the invention is understood to mean the number of hydrogen atoms that are active for the alkoxylation per molecule of the starter substance.

### Component K

Compounds suitable as component K are characterized in that they contain at least one phosphorus-oxygen-hydrogen group. Preferably, component K is selected from at least one compound from the group consisting of

phosphoric acid,

mono- and dialkyl esters of phosphoric acid,

mono- and diaryl esters of phosphoric acid,

mono- and dialkaryl esters of phosphoric acid,

(NH4)2HPO4,

phosphonic acid,

monoalkyl esters of phosphonic acid,

monoaryl esters of phosphonic acid,

monoalkaryl esters of phosphonic acid,

phosphorous acid,

mono- and dialkyl esters of phosphorous acid,

mono- and diaryl esters of phosphorous acid,

mono- and dialkaryl esters of phosphorous acid and

phosphinic acid.

The mono- or dialkyl esters of phosphoric acid are preferably the mono- or dialkyl esters of orthophosphoric acid, mono-, di- or trialkyl esters of pyrophosphoric acid and mono-, di-, tri-, tetra- or polyalkyl esters of polyphosphoric acid, more preferably the respective esters with alcohols having 1 to 30 carbon atoms. The mono- or diaryl esters of phosphoric acid are preferably the mono- or diaryl esters of orthophosphoric acid, mono-, di- or triaryl esters of pyrophosphoric acid and mono-, di-, tri-, tetra- or polyaryl esters of polyphosphoric acid, more preferably the respective esters with alcohols having 6 to 10 carbon atoms. The mono- or dialkaryl esters of phosphoric acid are preferably the mono- or dialkaryl esters of orthophosphoric acid, mono-, di- or trialkaryl esters of pyrophosphoric acid and mono-, di-, tri-, tetra- or polyalkaryl esters of polyphosphoric acid, more preferably the respective esters with alcohols having 7 to 30 carbon atoms. Examples of compounds suitable as component K include: diethyl phosphate, monoethyl phosphate, dipropyl phosphate, monopropyl phosphate, dibutyl phosphate, monobutyl phosphate, diphenyl phosphate, dicresyl phosphate, fructose 1,6-biphosphate, glucose 1-phosphate, bis(4-nitrophenyl) phosphate, dibenzyl phosphate, diethyl 3-butenyl phosphate, dihexadecyl phosphate, diphenyl phosphate and 2-hydroxyethyl methacrylate phosphate.

Monoalkyl esters of phosphonic acid used with preference are the respective esters with alcohols having 1 to 30 carbon atoms. Monoaryl esters of phosphonic acid used with preference are the respective esters with alcohols having 6 to 10 carbon atoms. Monoalkaryl esters of phosphonic acid used with preference are the respective esters with alcohols having 7 to 30 carbon atoms.

Mono- and dialkyl esters of phosphorous acid used with preference are esters with alcohols having 1 to 30 carbon atoms. This includes, for example, phenylphosphonic acid, butylphosphonic acid, dodecylphosphonic acid, ethylhexylphosphonic acid, octylphosphonic acid, ethylphosphonic acid, methylphosphonic acid and octadecylphosphonic acid. Mono- and diaryl esters of phosphorous acid used with preference are the respective esters with alcohols having 6 to 10 carbon atoms. Mono- and dialkaryl esters of phosphorous acid used with preference are the respective esters with alcohols having 7 to 30 carbon atoms.

Component K is more preferably selected from at least one compound from the group consisting of phosphoric acid, phosphonic acid and phosphinic acid. Component K is most preferably phosphoric acid.

The alcohols having 1 to 30 carbon atoms recited in the description of component K are for example methanol, ethanol, propanol, butanol, pentanol, hexanol, heptanol, octanol, nonanol, decanol, dodecanol, tridecanol, tetradecanol, pentadecanol, hexadecanol, heptadecanol, octadecanol, nonadecanol, methoxymethanol, ethoxymethanol, propoxymethanol, butoxymethanol, 2-ethoxyethanol, 2-propoxyethanol, 2-butoxyethanol, phenol, ethyl hydroxyacetate, propyl hydroxyacetate, ethyl hydroxypropionate, propyl hydroxypropionate, 1,2-ethanediol, 1,2-propanediol, 1,2,3-trihydroxypropane, 1,1,1-trimethylolpropane or pentaerythritol.

Also suitable as component K are compounds of phosphorus that can form one or more phosphorus-oxygen-hydrogen groups by reaction with OH-functional compounds (such as water for example). Examples of such compounds of phosphorus that are useful include phosphorus(V) sulfide, phosphorus tribromide, phosphorus trichloride and phosphorus triiodide.

It is also possible to use any desired mixtures of the aforementioned compounds as component K. Component K can also be used in admixture with suspension medium or in admixture with trialkyl phosphate (in particular triethyl phosphate).

Component K can be metered in any desired step of the process. It is advantageous to meter in component K in step (γ), especially when H-functional starter substance is metered in step (γ). It is also advantageous to add component K to the reaction mixture in the postreactor in step (δ). It is additionally advantageous to add component K to the reaction mixture obtained only after the postreaction (step (δ)).

In one possible embodiment of the invention, during the postreaction (step (δ)), component K is added in an amount of 5 ppm to 1000 ppm, more preferably 10 ppm to 500 ppm, most preferably 20 ppm to 200 ppm, based in each case on the reaction mixture obtained in step (γ). Component K is added during the postreaction more preferably at a free alkylene oxide content of 0.1 g/l to 10 g/l, most preferably of 1 g/l to 10 g/l of alkylene oxide and especially most preferably of 5 g/l to 10 g/l. When conducting the process of the invention using a tubular reactor for the postreaction in step (δ), component K is more preferably metered in the second half of the distance that the reaction mixture traverses in the tubular reactor.

The polyether carbonate polyols obtained in accordance with the invention have a functionality of, for example, at least 1, preferably of 1 to 8, more preferably of 1 to 6 and most preferably of 2 to 4. The molecular weight is preferably 400 to 10 000 g/mol and more preferably 500 to 6000 g/mol.

The polyether carbonate polyols obtainable by the process of the invention have a low content of by-products and can be processed without difficulty, especially by reaction with di- and/or polyisocyanates to afford polyurethanes, in particular flexible polyurethane foams. For polyurethane applications, it is preferable to use polyether carbonate polyols based on an H-functional starter substance having a functionality of at least 2.

In addition, the polyether carbonate polyols obtainable by the process of the invention can be used in applications such as washing and cleaning composition formulations, drilling fluids, fuel additives, ionic and nonionic surfactants, lubricants, process chemicals for papermaking or textile manufacture, or cosmetic formulations.

The person skilled in the art is aware that, depending on the respective field of use, the polyether carbonate polyols to be used have to fulfill certain physical properties, for example molecular weight, viscosity, functionality and/or hydroxyl number.

In a first embodiment, the invention thus relates to a process for preparing polyether carbonate polyols from H-functional starter substance, alkylene oxide and carbon dioxide in the presence of a double metal cyanide (DMC) catalyst or in the presence of a metal complex catalyst based on the metals zinc and/or cobalt, wherein the carbon dioxide used has a purity of 99.5000% to 99.9449% by volume.

In a second embodiment, the invention relates to a process according to the first embodiment, wherein the carbon dioxide used has a purity of 99.9000% to 99.9449% by volume.

In a third embodiment, the invention relates to a process according to the first or second embodiment, which is conducted in the presence of at least one DMC catalyst.

In a fourth embodiment, the invention relates to a process according to any of embodiments 1 to 3, characterized in that the process is conducted in the presence of at least one DMC catalyst and in that
(α) H-functional starter substance and/or a suspension medium containing no H-functional groups is initially charged and any water and/or other volatile compounds are removed by elevated temperature and/or reduced pressure, with addition of the DMC catalyst to the H-functional starter substance or to the suspension medium before or after the drying,
(β) a portion of alkylene oxide is added to the mixture from step (α) at temperatures of 90 to 150° C., and then the addition of the alkylene oxide is stopped,
(γ) alkylene oxide and carbon dioxide and optionally H-functional starter substance are added to the mixture resulting from step (0),
wherein H-functional starter substance is used at least in one of steps (α) and (γ).

In a fifth embodiment, the invention relates to a process according to any of embodiments 1 to 4, characterized in that
(γ) H-functional starter substance(s), alkylene oxide and carbon dioxide are metered continuously into the reactor during the reaction.

In a sixth embodiment, the invention relates to a process according to the fifth embodiment, characterized in that the process is conducted in the presence of at least one DMC catalyst and wherein, in step (γ), DMC catalyst is additionally metered continuously into the reactor and the resulting reaction mixture is removed continuously from the reactor.

In a seventh embodiment, the invention relates to a process according to the sixth embodiment, wherein
(δ) the reaction mixture which is removed continuously in step (γ) and has a content of 0.05% by weight to 10% by weight of alkylene oxide is transferred into a postreactor in which the free alkylene oxide content is reduced to less than 0.05% by weight in the reaction mixture by way of postreaction.

In an eighth embodiment, the invention relates to a process according to any of embodiments 4 to 7, wherein the suspension medium used in step (α) is at least one compound selected from the group consisting of 4-methyl-2-oxo-1,3-dioxolane, 1,3-dioxolan-2-one, acetone, methyl ethyl ketone, acetonitrile, nitromethane, dimethyl sulfoxide, sulfolane, dimethylformamide, dimethylacetamide, N-methylpyrrolidone, dioxane, diethyl ether, methyl tert-butyl ether, tetrahydrofuran, ethyl acetate, butyl acetate, pentane, n-hexane, benzene, toluene, xylene, ethylbenzene, chloroform, chlorobenzene, dichlorobenzene, carbon tetrachloride, ε-caprolactone, dihydrocoumarin, trimethylene carbonate, neopentyl glycol carbonate, 3,6-dimethyl-1,4-dioxane-2,5-dione, succinic anhydride, maleic anhydride and phthalic anhydride.

In a ninth embodiment, the invention relates to a process according to any of embodiments 1 to 8, wherein component K is added at any time, wherein component K is selected from at least one compound from the group consisting of
phosphoric acid,
mono- and dialkyl esters of phosphoric acid,
mono- and diaryl esters of phosphoric acid,
mono- and dialkaryl esters of phosphoric acid,
(NH4)2HPO4,
phosphonic acid,
monoalkyl esters of phosphonic acid,
monoaryl esters of phosphonic acid,
monoalkaryl esters of phosphonic acid,
phosphorous acid,
mono- and dialkyl esters of phosphorous acid,
mono- and diaryl esters of phosphorous acid,
mono- and dialkaryl esters of phosphorous acid,
phosphinic acid.

In a tenth embodiment, the invention relates to a process according to the ninth embodiment, wherein component K is selected from at least one compound from the group consisting of phosphoric acid, phosphonic acid and phosphinic acid.

In an eleventh embodiment, the invention relates to a process according to any of embodiments 1 to 10, wherein the H-functional starter substance is selected from at least one of the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane, pentaerythritol, sorbitol, polyether carbonate polyols having a molecular weight Mn in the range from 150 to 8000 g/mol with a functionality of 2 to 3, and polyether polyols having a molecular weight Mn in the range from 150 to 8000 g/mol with a functionality of 2 to 3.

In a twelfth embodiment, the invention relates to a process according to any of embodiments 7 to 11, wherein in step (δ) the reaction mixture obtained in step (γ) is transferred continuously into a postreactor, wherein the postreactor is a tubular reactor.

In a thirteenth embodiment, the invention relates to a process according to any of embodiments 7 to 12, wherein in step (δ) the reaction mixture obtained in step (γ) is transferred continuously into a postreactor, wherein the free alkylene oxide content is reduced to less than 0.5 g/l by way of postreaction.

### EXAMPLES

The hydroxyl number (OH number) was determined by the method of DIN 53240. The statement of unit in “mgKOH/g” relates to mg[KOH]/g [polyether carbonate polyol].

Viscosity was determined by means of a rotary viscometer (Physica MCR 51, manufacturer: Anton Paar) by the method of DIN 53018.

The purity of the carbon dioxide used was ascertained by the “EIGA IGC Doc 70/08/E” method established by the EUROPEAN INDUSTRIAL GASES ASSOCIATION AISBL (Carbon Dioxide Source Qualification Quality Standards And Verification), and the analysis methods in relation to the individual components specified in “Appendix D” therein.

The fraction of incorporated CO₂ in the resulting polyether carbonate polyol (“CO₂ incorporated”) and the ratio of propylene carbonate (cyclic carbonate) to polyether carbonate polyol were determined by ¹H NMR (Bruker DPX 400, 400 MHz; pulse program zg30, relaxation delay dl: 10 s, 64 scans). Each sample was dissolved in deuterated chloroform. The relevant resonances in the ¹H NMR (based on TMS=0 ppm) are as follows:

Cyclic carbonate (which was formed as a by-product) resonance at 4.5 ppm, linear carbonate resulting from carbon dioxide incorporated in the polyether carbonate polyol (resonances at 5.1 to 4.8 ppm), unreacted propylene oxide (PO) with resonance at 2.4 ppm, polyether polyol (i.e. without incorporated carbon dioxide) with resonances at 1.2 to 1.0 ppm.

The mole fraction of the carbonate incorporated in the polymer in the reaction mixture is calculated as per formula (VIII) as follows, the following abbreviations being used:

A(4.5)=area of the resonance at 4.5 ppm for cyclic carbonate (corresponds to a hydrogen atom)

A(5.1-4.8)=area of the resonance at 5.1-4.8 ppm for polyether carbonate polyol and a hydrogen atom for cyclic carbonate

A(2.4)=area of the resonance at 2.4 ppm for free, unreacted PO

A(1.2-1.0)=area of the resonance at 1.2-1.0 ppm for polyether polyol

Taking account of the relative intensities, the values for the polymer-bound carbonate (“linear carbonate” LC) in the reaction mixture were converted to mol % as per the following formula (VIII):

$$L C = \frac{A ( 5.1 - 4.8 ) - A ( 4.5 )}{\begin{matrix}A ( 5.1 - 4.8 ) + A ( 2.4 ) + 0.33 * A ( 1.2 - 1.0 ) + \\ 0.25 * A ( 1.6 - 1.52 )\end{matrix}} * 100 \qquad ( VIII )$$

The proportion by weight (in % by weight) of polymer-bound carbonate (LC′) in the reaction mixture was calculated by formula (IX):

$$L {C}^{′} = \frac{[ A ( 5.1 - 4.8 ) - A ( 4.5 ) ] * 102}{D} * 100 \% \qquad ( IX )$$

where the value of D (“denominator” D) is calculated by formula (X):

D=[A(5.1-4.8)−A(4.5)]*102+A(4.5)*102+A(2.4)*58+0.33*A(1.2-1.0)*58+0.25*A(1.6-1.52)*146 (X)

The factor of 102 results from the sum of the molar masses of CO₂ (molar mass 44 g/mol) and of propylene oxide (molar mass 58 g/mol); the factor of 58 results from the molar mass of propylene oxide.

The proportion by weight (in % by weight) of cyclic carbonate (CC′) in the reaction mixture was calculated by formula (XI):

$$C {C}^{′} = \frac{A ( 4.5 ) * 102}{D} * 100 \% \qquad ( XI )$$

where the value of D is calculated by formula (X).

In order to calculate the composition based on the polymer component (consisting of polyether which has been formed from propylene oxide during the activation steps which take place under CO₂-free conditions, and polyether carbonate polyol formed from starter, propylene oxide and carbon dioxide during the activation steps which take place in the presence of CO₂ and during the copolymerization) from the values for the composition of the reaction mixture, the non-polymeric constituents of the reaction mixture (i.e. cyclic propylene carbonate and any unconverted propylene oxide present) were mathematically eliminated. The weight fraction of the repeat carbonate units in the polyether carbonate polyol was converted to a proportion by weight of carbon dioxide using the factor A=44/(44+58). The figure for the CO₂ content in the polyether carbonate polyol (“CO₂ incorporated”; see examples which follow and table 1) is normalized to the polyether carbonate polyol molecule which has formed in the copolymerization and the activation steps.

The amount of cyclic carbonate formed is determined via the mass balance of the total amount of cyclic propylene carbonate present in the reaction mixture and the amount of propylene carbonate used as the initial charge.

### Raw Materials Used:

DMC catalyst: a dried and ground DMC catalyst (double metal cyanide catalyst) prepared according to example 6 of WO 2001/80994 A1
Glycerol: from Aug. Hedinger GmbH & Co. KG
Propylene glycol: from Aug. Hedinger GmbH & Co. KG
The purity of the CO₂ qualities used was as follows:
   CO₂ purity “2.5”: 99.5000%-99.8999% by volume of CO₂
   CO₂ purity “3.0”: 99.9000%-99.9449% by volume of CO₂
   CO₂ purity “4.5”: 99.9950%-99.9974% by volume of CO₂
   CO₂ purity “4.8”: 99.9975%-99.9984% by volume of CO₂

### Preparation of Polyether Carbonate Polyols:

### Example 1

A nitrogen-purged 60 L pressure reactor comprising a gas metering unit was initially charged with a suspension of 14.9 g of dried DMC catalyst and 4700 g of cyclic propylene carbonate (cPC). The reactor was heated to about 100° C. and inertized with N₂ at reduced pressure (100 mbar) for 1 h. Subsequently, CO₂ of purity “3.0” (99.9000%-99.9449% by volume of CO₂) was injected to a pressure of 74 bar. 500 g of propylene oxide (PO) were rapidly metered into the reactor at 110° C. with stirring (316 rpm). The onset of the reaction was signaled by a temperature spike (“hotspot”) and a pressure drop. On completion of activation, the remaining propylene oxide (33.58 kg) at 8.2 kg/h and 1.1 kg of a mixture of the glycerol starter (spiked with 180 ppm of 85% H₃PO₄) and monopropylene glycol (weight ratio 85/15) at 0.29 kg/h were metered simultaneously into the reactor. The reaction temperature was simultaneously lowered to 105° C. The progress of the reaction was monitored via the CO₂ consumption, keeping the pressure in the reactor at 74 bar by continuous replenishment under closed-loop control. After the addition of PO had ended, the mixture was stirred at 316 rpm until no further drop in the pressure was recorded. Finally, volatile constituents were removed by thin-film evaporation (temperature=160° C., pressure=0.3 mbar, throughput=6 kg/h).

### Analytical Data:

OH number: 48.0 mg KOH/g

Viscosity 25° C.: 26400 mPas

CO₂ incorporated: 21.31% by weight

Selectivity (cyclic/linear carbonate): 0.198

### Example 2 (Comparative)

Example 2 (comparative) was conducted analogously to example 1, except that CO₂ of “4.5” purity (99.9950%-99.9974% by volume of CO₂) rather than CO₂ of “3.0” purity was used.

### Analytical Data:

OH number: 48.2 mg KOH/g

Viscosity 25° C.: 22800 mPas

CO₂ incorporated: 20.84% by weight

Selectivity (cyclic/linear carbonate): 0.227

### Example 3

A nitrogen-purged 1 L pressure reactor comprising a gas metering unit was initially charged with 136 mg of dried DMC catalyst and 121 g of cyclic propylene carbonate (cPC). The reactor was heated to about 130° C. and inertized with N₂ at reduced pressure (75 mbar) for 1 h. 10 g of propylene oxide (PO) were rapidly metered into the reactor while stirring (1200 rpm). The onset of the reaction was signaled by a temperature spike (“hotspot”) and a pressure drop. Subsequently, CO₂ of “3.0” purity (99.9000%-99.9449% by volume of CO₂) was injected to 50 bar and another 10 g of PO were then added. After another temperature peak, 482 g of PO were metered simultaneously into the reactor at 2.2 g/min and 18 g of glycerol (spiked with 25 mg of H₃PO₄) at 0.1 g/min. The reaction temperature was lowered here to 105° C. The progress of the reaction was monitored via the CO₂ consumption, keeping the pressure in the reactor at 50 bar by continuous replenishment under closed-loop control. After the addition of PO had ended, the mixture was stirred at 1200 rpm until no further drop in the pressure was recorded. Finally, volatile constituents were removed by thin-film evaporation.

### Analytical Data:

OH number: 57.3 mg KOH/g

CO₂ incorporated: 17.72% by weight

Selectivity (cyclic/linear carbonate): 0.09

### Example 4 (Comparative)

Example 4 (comparative) was conducted analogously to example 3, except that CO₂ of “4.8” purity (99.9975%-99.9984% by volume of CO₂) rather than CO₂ of “3.0” purity was used.

### Analytical Data:

OH number: 58.7 mg KOH/g

CO₂ incorporated: 17.80% by weight

Selectivity (cyclic/linear carbonate): 0.13

Table 1 summarizes the results of examples 1 to 4 for the polyether carbonate polyol preparation, reporting the following results:
OH number: the hydroxyl number of the polyether carbonate polyols obtained,
Viscosity (25° C.): the viscosity of the polyether carbonate polyols obtained at 25° C.
Incorporated CO₂: the content of carbon dioxide (CO₂) incorporated into the polyether carbonate polyols,
Selectivity [cyclic/linear carbonate]: Ratio of propylene carbonate (cyclic carbonate) to polyether carbonate polyol (linear carbonate) in the reaction product obtained from the copolymerization

TABLE 1
Results of the polyether carbonate polyol preparation

| | | | | CO₂ | Selectivity |
|---|---|---|---|---|---|
| | | OH number | Viscosity 25° C. | incorporated | [cyclic/linear |
| Example | CO₂ quality | [mg KOH/g] | [mPas] | [% by wt.] | carbonate] |
| 1 | 3.0 | 48.0 | 26400 | 21.31 | 0.198 |
| 2*⁾ | 4.5 | 48.2 | 22800 | 20.84 | 0.227 |
| 3 | 3.0 | 57.3 | not determined | 17.72 | 0.09 |
| 4*⁾ | 4.8 | 58.7 | not determined | 17.80 | 0.13 |

*⁾comparative example

A comparison of inventive example 1 with example 2 (comparative) and of inventive example 3 with example 4 (comparative) shows that much better selectivities (lower ratios of cyclic/linear carbonate) are obtained in each case when the CO₂ used has a purity of 99.9000% to 99.9449% by volume.

### Example 5

A continuously operated 60 L pressure reactor with gas metering unit and product discharge tube was initially charged with 32.9 L of a polyether carbonate polyol (OH functionality=2.8; OH number=56 mg KOH/g; CO₂ content=20% by weight) containing 200 ppm of DMC catalyst. At a temperature of 108° C. and a total pressure of 65 bar (absolute), the following components were metered at the metering rates specified while stirring (9 Hz):
propylene oxide at 7.0 kg/h
carbon dioxide of “2.5” purity (99.5000%-99.8999% by volume of CO₂) at 2.3 kg/h
mixture of glycerol/propylene glycol (85% by weight/15% by weight) containing 0.69% by weight of DMC catalyst (unactivated) and 146 ppm (based on the mixture of glycerol, propylene glycol and DMC catalyst) of H₃PO₄ (used in the form of an 85% aqueous solution) at 0.27 kg/h.

The reaction mixture was withdrawn continuously from the pressure reactor via the product discharge tube, such that the reaction volume (32.9 L) was kept constant, with a mean residence time of the reaction mixture in the reactor of 200 min.

To complete the reaction, the reaction mixture withdrawn was transferred into a postreactor (tubular reactor having a reaction volume of 2.0 L) which had been heated to 120° C. The mean residence time of the reaction mixture in the postreactor was 12 min. The product was then decompressed to atmospheric pressure and then 500 ppm of Irganox® 1076 antioxidant were added.

Subsequently, the product was brought to a temperature of 120° C. by means of a heat exchanger and immediately thereafter transferred to a 332 L tank and kept at the temperature of 120° C. for a residence time of 4 hours.

On completion of the residence time, the product was admixed with 40 ppm of phosphoric acid (component K).

Finally, the product, for removal of the cyclic propylene carbonate, was subjected to a two-stage thermal workup, namely in a first stage by means of a falling-film evaporator, followed, in a second stage, by a stripping column operated in a nitrogen countercurrent.

The falling-film evaporator was operated here at a temperature of 160° C. and a pressure of 10 mbar (absolute). The falling-film evaporator used consisted of glass with an exchange area of 0.5 m². The apparatus had an externally heated tube with a diameter of 115 mm and a length of about 1500 mm.

The nitrogen stripping column was operated at a temperature of 160° C., a pressure of 80 mbar (absolute) and a nitrogen flow rate of 0.6 kg N₂/kg product. The stripping column used was a DN80 glass column filled to a height of 8 m with random packings (Raschig #0.3 Super-Rings).

The cyclic carbonate content after thermal stress on the polyether carbonate polyol was assessed using the two following methods of practical relevance: firstly the cyclic carbonate content after a two-stage thermal workup and secondly the cyclic carbonate content after storage (66 h at 100° C.) of the worked-up polyether carbonate polyol.

The OH number, the viscosity, the content of carbon dioxide incorporated and the content of cyclic carbonate (“cPC”, table 2) of the polyether carbonate polyol obtained were determined. To ascertain the thermal storage stability of the polyether carbonate polyol (after the two-stage thermal workup), it was stored at 100° C. for 66 hours. Subsequently, the cyclic carbonate content in the polyether carbonate polyol thus stored was measured (“cPC@66b/100° C.”, table 2).

### Example 6

Example 6 was conducted analogously to example 5, except that CO₂ of “3.0” purity (99.9000%-99.9449% by volume of CO₂) rather than CO₂ of “2.5” purity was used.

### Example 7 (Comparative)

Example 7 (comparative) was conducted analogously to example 5, except that CO₂ of “4.5” purity (99.9950%-99.9974% by volume of CO₂) rather than CO₂ of “2.5” purity was used.

Table 2 summarizes the results of examples 5 to 7 for the polyether carbonate polyol preparation, reporting the following results:
OH number: the hydroxyl number of the polyether carbonate polyols obtained,
Viscosity (25° C.): viscosity of the polyether carbonate polyols obtained at 25° C.
CO₂ incorporated: content of carbon dioxide (CO₂) incorporated into the polyether carbonate polyols,
cPC: content of cyclic propylene carbonate after the two-stage thermal workup and
cPC @66 h/100° C.: content of cyclic propylene carbonate after storage at 100° C. for 66 hours.

TABLE 2
Results of the polyether carbonate polyol preparation

| | | | Viscosity | CO₂ | | |
|---|---|---|---|---|---|---|
| | | OH number | 25° C. | incorporated | cPC | cPC@66 h/100° C. |
| Example | CO₂ quality | [mg KOH/g] | [mPas] | [% by wt.] | [ppm] | [ppm] |
| 5 | 2.5 | 57.5 | 14100 | 19.2 | 20 | 47 |
| 6 | 3.0 | 57.6 | 14850 | 19.4 | 22 | 37 |
| 7*⁾ | 4.5 | 57.9 | 14500 | 19.2 | 38 | 184 |

*⁾comparative example

A comparison of inventive examples 5 and 6 with example 7 (comparative) shows that the polyether carbonate polyols have elevated storage stability (lower content of cyclic carbonate after thermal stress) when the CO₂ used has a purity of 99.5000%-99.8999% by volume (2.5 quality) or 99.9000% to 99.9449% by volume (3.0 quality). It is found to be particularly advantageous to use CO₂ having a purity of 99.9000% to 99.9449% by volume (3.0 quality) (example 6), since about a comparable level of cPC content is achieved here after the two-stage thermal workup to that achieved in the case of use of CO₂ with a purity of 99.5000%-99.8999% by volume (2.5 quality), but a very low content of cyclic carbonate (cPC@661/100° C.) is additionally found after storage at 100° C. for 66 h.

1. A process for preparing polyether carbonate polyols comprising reacting an H-functional starter substance, an alkylene oxide and carbon dioxide in the presence of a double metal cyanide (DMC) catalyst or in the presence of a metal complex catalyst based on the metals zinc and/or cobalt, wherein said carbon dioxide has a purity of 99.5000% to 99.9449% by volume.

2. The process as claimed in claim 1, wherein the carbon dioxide used has a purity of 99.9000% to 99.9449% by volume.

3. The process as claimed in claim 1, which is conducted in the presence of at least one DMC catalyst.

4. The process as claimed in claim 1, which is conducted in the presence of at least one DMC catalyst, and comprises
(α) initially charging said H-functional starter substance and/or a suspension medium containing no H-functional groups, and drying at elevated temperature and/or reduced pressure to remove any water and/or other volatile compounds, with addition of said DMC catalyst to said H-functional starter substance or to said suspension medium before or after the drying,
(β) adding a portion of alkylene oxide to the mixture from (α) at temperatures of 90 to 150° C., and then stopping the addition of said alkylene oxide,
(γ) adding alkylene oxide and carbon dioxide and optionally H-functional starter substance to the mixture resulting from (β),
wherein said H-functional starter substance is used at least in one of (α) and (γ).

5. The process as claimed in claim 1, comprising
(γ) continuously metering said H-functional starter substance(s), alkylene oxide and carbon dioxide into the reactor during the reaction.

6. The process as claimed in claim 5, wherein the process is conducted in the presence of at least one DMC catalyst and (γ) continuously metering said DMC catalyst into the reactor and continuously removing the resulting reaction mixture from the reactor.

7. The process as claimed in claim 6, comprising
(δ) continuously removing reaction mixture in (γ) transferring the reaction mixture which has a content of 0.05% by weight to 10% by weight of alkylene oxide into a postreactor, and reducing the free alkylene oxide content to less than 0.05% by weight in the reaction mixture by way of postreaction.

8. The process as claimed in claim 4, wherein said suspension medium in (α) comprises at least one of 4-methyl-2-oxo-1,3-dioxolane, 1,3-dioxolan-2-one, acetone, methyl ethyl ketone, acetonitrile, nitromethane, dimethyl sulfoxide, sulfolane, dimethylformamide, dimethylacetamide, N-methylpyrrolidone, dioxane, diethyl ether, methyl tert-butyl ether, tetrahydrofuran, ethyl acetate, butyl acetate, pentane, n-hexane, benzene, toluene, xylene, ethylbenzene, chloroform, chlorobenzene, dichlorobenzene, carbon tetrachloride, ε-caprolactone, dihydrocoumarin, trimethylene carbonate, neopentyl glycol carbonate, 3,6-dimethyl-1,4-dioxane-2,5-dione, succinic anhydride, maleic anhydride and phthalic anhydride.

9. The process as claimed in claim 1, comprising adding component K at any time, wherein component K comprises at least one of
phosphoric acid,
mono- and dialkyl esters of phosphoric acid,
mono- and diaryl esters of phosphoric acid,
mono- and dialkaryl esters of phosphoric acid,
(NH4)2HPO4,
phosphonic acid,
monoalkyl esters of phosphonic acid,
monoaryl esters of phosphonic acid,
monoalkaryl esters of phosphonic acid,
phosphorous acid,
mono- and dialkyl esters of phosphorous acid,
mono- and diaryl esters of phosphorous acid,
mono- and dialkaryl esters of phosphorous acid,
and
phosphinic acid.

10. The process as claimed in claim 9, wherein component K comprises at least one of phosphoric acid, phosphonic acid and phosphinic acid.

11. The process as claimed in claim 1, wherein said H-functional starter substance comprises at least one of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane, pentaerythritol, sorbitol, and polyether carbonate polyols having a molecular weight Mn in the range from 150 to 8000 g/mol with a functionality of 2 to 3, and polyether polyols having a molecular weight Mn in the range from 150 to 8000 g/mol with a functionality of 2 to 3.

12. The process as claimed in claim 7, comprising (δ) continuously transferring said reaction mixture obtained in (γ) into a postreactor, wherein the postreactor is a tubular reactor.

13. The process as claimed in claim 7, comprising (δ) continuously transferring said reaction mixture obtained in (γ) into a postreactor, and reducing the free alkylene oxide content to less than 0.5 g/l by way of postreaction.
